(19) United States
(12) Patent Application Publication
(10) Pub. No.: US 2025/0306861 A1
(43) Pub. Date: Oct. 2, 2025

(54) DYNAMIC APPLICATION CONTENT ENRICHMENT FOR AI-ASSISTED CODE GENERATION TOOLS

(71) Applicant: The PNC Financial Services Group, Inc., Pittsburgh, PA (US)

(72) Inventors: Vorachat Tamarree, Pittsburgh, PA (US); Brianna Hogan, Coraopolis, PA (US); Matthew Thompson, Upper St. Clair, PA (US); Aliyah Flores, Pittsburgh, PA (US)

(21) Appl. No.: 18/912,756

(22) Filed: Oct. 11, 2024

Related U.S. Application Data
(60) Provisional application No. 63/570,479, filed on Mar. 27, 2024.

(51) Int. Cl. G06F 8/30; G06F 8/73; G06F 16/332

(52) U.S. Cl. CPC G06F 8/30; G06F 8/73; G06F 16/3329

(57) ABSTRACT

Computer-implemented systems and methods use an AI-assisted code generation tool with the dynamic application context enrichment engine that collects, iteratively if necessary, contextual data about IT infrastructure of the enterprise, such as contextual information from architectural systems, tools and platforms of the enterprise. That enriched contextual information can be passed to the AI-assisted code generation tool so that the AI-assisted code generation tool can provide more well-informed, tailored responses for the user.

### PRIORITY CLAIM

The application claims priority, and incorporates herein by reference in its entirety, U.S. provisional patent application Ser. No. 63/570,479, filed Mar. 27, 2024.

### BACKGROUND

The overall goal of software development is to deliver a high-quality application that meets both functional and non-functional requirements. While requirements at the file level can be met using existing AI-Assisted Software Development technology, many of the broader, non-functional application requirements are not well addressed or supported by such tools. These tools, such as GitHub Copilot and Tabnine, utilize artificial intelligence to assist software developers in their coding tasks, such as by providing suggestions, fixing errors, and even writing code snippets, all with the aim of making the coding experience smoother and more efficient.

Traditionally, AI code assistants relied on Natural Language Processing (NLP) techniques. These techniques allow the assistant to process large amounts of code data, understand coding patterns and structures, and generate suggestions or insights that can be useful for developers in their current context. With the recent advances in generative AI, modern code assistants incorporate large language models (LLMs) like GPT-3.5 and GPT-4 to provide more value and perform a wider variety of tasks. These LLMs can generate human-like text and code based on the context given to them. When applied to code, they can create syntactically correct, contextually appropriate code segments. They can also interpret prompts provided in natural language, adding another layer of convenience and utility for developers.

Such AI-assisted code generation tools, however, are not well suited for addressing application-level non-functional code requirements, such as requirements that outline how well it operates, including attributes such as speed, security, reliability, and data integrity. Additionally, generative AI tools work on tokens and have limits on ingestion of tokens. Tokens can be thought of as pieces of words. Before the API for the gen-AI tool processes the request, the input is broken down into tokens. These tokens are not cut up exactly where the words start or end; tokens can include trailing spaces and even sub-words. Different gen-AI models have different token limits, which can be as low as several thousand (e.g., 8,000) tokens per request.

### SUMMARY

Assume that a software developer at an enterprise is using an AI-assisted code generation tool to write or improve a software application for the enterprise. In one general aspect, the present invention is directed to a new architecture for using such AI-assisted code generation tools, where the new architecture includes a so-called “dynamic application context enrichment engine” or “DACE engine” that collects, iteratively if necessary, contextual data about IT infrastructure of the enterprise, such as contextual information from architectural systems, tools and platforms of the enterprise. That enriched contextual information can be passed to the AI-assisted code generation tool so that the AI-assisted code generation tool can provide more well-informed, tailored responses for the user (e.g., the software developer). The DACE engine can iterate with the systems of the enterprise to drill down to files, classes, sub-sets, etc. of the enterprise's application to isolate the most relevant information for the AI-assisted code generation tool, which has the added benefit of reducing the number of tokens sent to the AI-assisted code generation tool. The DACE engine can also send documentation with contextual information about the codebase for the application, such as a graphical representation of the codebase for the application, to the AI-assisted code generation tool to aid the AI-assisted code generation tool in responding to the user's query. The contextual documentation can be prepared in advance and stored in a database that the DACE engine can query for relevant documentation. These and other benefits that can be realized through embodiments of the present invention will be apparent from the description that follows.

### FIGURES

Various embodiments of the present invention are described herein by way of example in conjunction with the following figures.

FIG. 1 is a diagram of a prior art architecture for AI-assisted code generation tools.

FIG. 2 is a diagram of a new architecture for AI-assisted code generation tools according to various embodiments of the present invention.

FIG. 3 is a flow chart of a process performed by the architecture of FIG. 2 according to various embodiments of the present invention.

FIGS. 4, 5 and 6 are diagrams depicting a sequence of operation for the system of FIG. 2 according to various embodiments of the present invention.

FIG. 7 is a diagram of an architecture for AI-assisted code generation tools according to other various embodiments of the present invention.

### DESCRIPTION

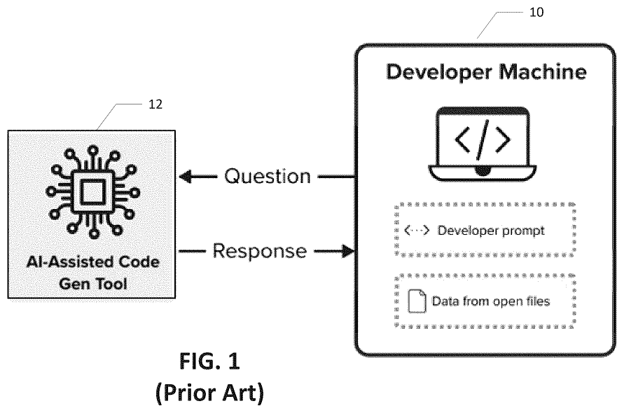

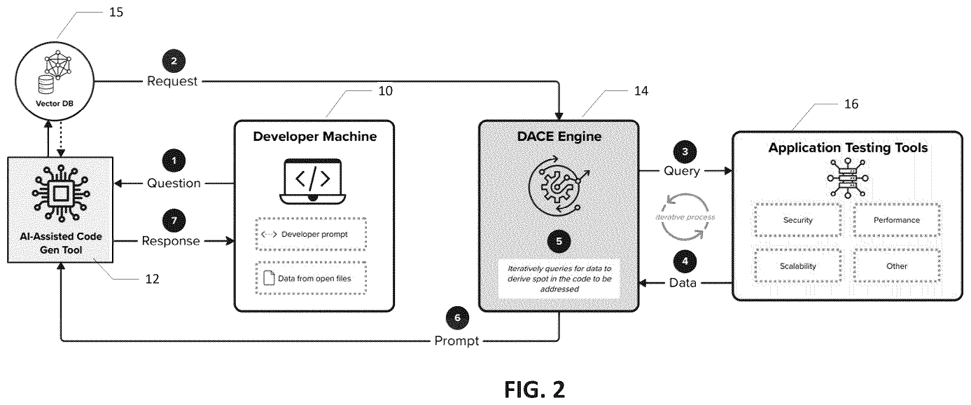

FIG. 1 depicts a typical, current AI-assisted code generation tool scenario. In the depicted scenario, the software developer, from a developer computer device 10, sends a question or query to an AI-assisted code generation tool 12, such as Copilot or Tabnine. In response, the AI-assisted code generation tool 12, based on its AI model(s), generates and delivers back to the developer machine 10 the response to the query. The AI-assisted code generation tool 12 can be provided online such as via a SaaS architecture. As such, the query/question and the response can be sent via the Internet or other electronic data network. The developer at the developer machine 10 may be writing software code for an application for a large enterprise, with many software systems and non-functional, enterprise-level code requirements. Notice, however, that in FIG. 1, the AI-assisted code generation tool 12 has limited information about the enterprise's software systems and non-functional code requirements. The AI-assisted code generation tool 12 typically only has information about the files that the developer machine has open, although some tools additionally have access to code repositories. FIG. 2 depicts an architecture according to various embodiments of the present invention for the developer's enterprise to provide more information to the AI-assisted code generation tool 12 so that the AI-assisted code generation tool 12 can make better, even holistic, code suggestions, code snippets, etc. The architecture of FIG. 2 includes the dynamic application context enrichment (“DACE”) engine 14 that, as described more fully below, provides information from application testing tools 16 of the enterprise so that the AI-assisted code generation tool 12 can provide better code suggestions, code snippets, etc. at the application level to the software developer at the developer machine 10.

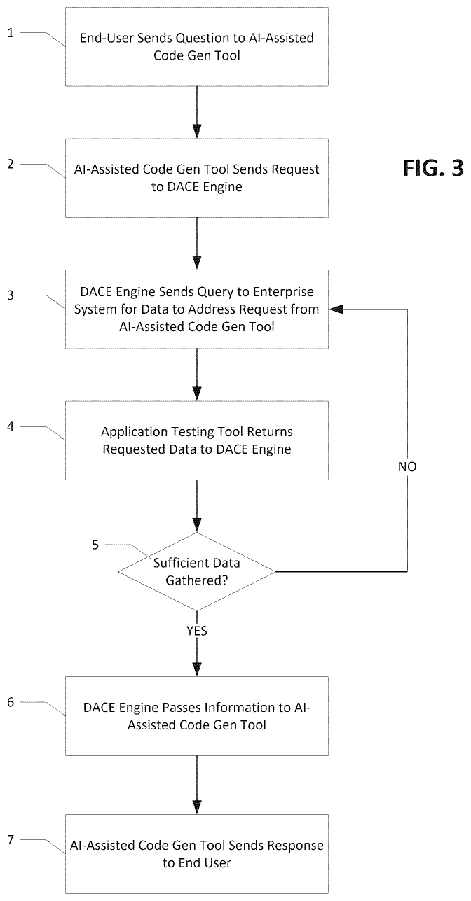

The flow chart of the FIG. 3 uses references numbers that correspond to steps shown in FIG. 2. At step 1, the end user, at a developer machine 10, transmits a question to the AI-assisted code generation tool 12. The AI-assisted code generation tool 12 can be an online SaaS tool so that the end user transmits the request via the Internet, for example. The question can be something that requires more information to answer than what the AI-assisted code generation tool 12 receives from the developer machine. For example, the end user's question could be something like, “Current response time for the application is 30 seconds; where in the code contributes most to this latency and how could we reduce the response time to 5 seconds?” Answering this question may require information about performance (e.g., latency) of systems of the enterprise. Based on the question asked, therefore, in certain embodiments of the present invention, the AI-assisted code generation tool 12 can then, in various embodiments, consult a vector database 15 for whether additional context is needed to respond to the user's query. The vector database 15 can store for retrieval high-dimensional numerical data, e.g., vectors. The vectors can represent information about the enterprise's codebase, computer infrastructure, applications, etc. That is, data about the enterprise's codebase, computer infrastructure, applications, etc. can be vectorized, with the corresponding vectors stored in the database. When the gen-AI tool 12 receives a request at step 1, it can query the vector database 15 to determine whether additional context is needed to respond to the user's query based on a similarity search. For example, the user's query can be converted to a vector, and similar vectors (e.g., based on cosine similarity), if any, can be identified in the vector database 15 that provide additional context for responding to the user's query. If the vector database 15 has insufficient information to help the gen-AI tool 12 respond to the user such that additional context is required, the gen-AI tool 12 can send, at step 2, a request to the DACE engine 14 of the enterprise for the additional context. The AI-assisted code generation tool 12 and the DACE engine 14 may communicate via an API(s), for example.

In other embodiments, the query by the AI-assisted code generation tool 12 of the vector database 15 omitted, such as if the query is optionally skipped or if there is no vector database 15 in the system. In such embodiments, every question asked to the AI-assisted code generation tool 12 can be passed directly to the DACE engine 14 for resolution as described herein.

The DACE engine 14 determines what system (or systems) of the enterprise has relevant data to address the request from the AI-assisted code generation tool 12 and, at step 3, the DACE engine 14 transmits a query to the relevant system(s) of the enterprise to obtain that data. FIG. 3 shows four types of systems that might have data to address requests from the AI-assisted code generation tool 12: a security system for security related questions; a performance system to address performance related questions; a scalability system to address scalability questions; and a generic other system for other types of system data. An example of the performance system for the enterprise is Dynatrace, which is a software observability platform. It provides automatic and intelligent observability across cloud and hybrid environments with continuous auto-discovery of hosts, VMs, serverless, cloud services, containers and Kubernetes, networks, devices, logs, events and more. Such software observability platform can identify calls, operations, microservices, etc. associated with application, including how long timewise each such action consumed, and even the code portion of the application that was being executed during the action.

Examples of possible security systems are SD Elements and CheckMarx. SD Elements is a security tool for software development. It is a software threat modeling tool that provides relevant countermeasures, compliance best practices, and actionable security requirements to developers in developing software applications. CheckMarx is a platform that allows developers to reduce risk across components of modern software, such as proprietary code, open-source code, and APIs. Another example security system is a system (such as Contrast from Contrast Security) that track possible API routes through an application and assesses them for vulnerabilities and other security issues. An example of a suitable scalability system is OpenShift, from Red Hat, for containerized applications. In the containerized application context, a pod is a collection of one or more containers. Container-focused scalability platforms, such as OpenShift, can identify pods that are running an application along with metrics about the pods, such as memory and CPU usage and network traffic, for example. Where an application is run on a virtual machine(s), a scalability system could capture similar data from the virtual machines.

At step 4, the system of the enterprise that is queried at step 3 responds to the DACE engine 14 with relevant data to the DACE engine's query. The DACE engine's data collection process preferably is iterative as shown by the feedback loop at step 5. That is, for example, the DACE engine 14 could iteratively request and receive more data by repeating steps 4 and 5 until it has sufficiently granular information to respond meaningfully to the AI-assisted code generation tool 12. That is, for example, the DACE engine 14 can iteratively collect more granular data until a detailed picture of the application is captured, all the way to the granular code level if necessary. For a performance issue, for example, the DACE engine 14 can iterate with the enterprise's performance system (e.g., Dynatrace) to identify operations that take too much time (e.g., bottlenecks) and the code (e.g., class, file, etc.) that the application was running/executing during those bottleneck operations. Analogously, for a scalability issue, the scalability system can collect the statistics for pods or virtual machines running the application.

Once the DACE engine 14 has identified and collection sufficiently granular information to respond to the AI-assisted code generation tool 12's request, the DACE engine 14 can package the response data and, at step 6, transmit that response data back to the AI-assisted code generation tool 12, such as via an API. The response data can be, for example, the code class for the bottleneck for a performance issue or pod/VM statistics for a scalability issue, etc. With the additional information from the DACE engine 14, the AI-assisted code generation tool 12 can craft a more meaningful, targeted response back to the end user, at step 7, containing a specific solution or suggestion to be implemented by the end user. The response to the end user can comprise a file, a class (e.g., an extensible program-code-template for creating objects), and/or code, for example.

Drilling down, by the DACE engine 14, to granular information for the AI-assisted code generation tool 12 has the added benefit of reducing the ingestion of tokens by the AI-assisted code generation tool 12 such that the response by the DACE engine 14 at step 6 satisfies the token limit of the AI-assisted code generation tool 12.

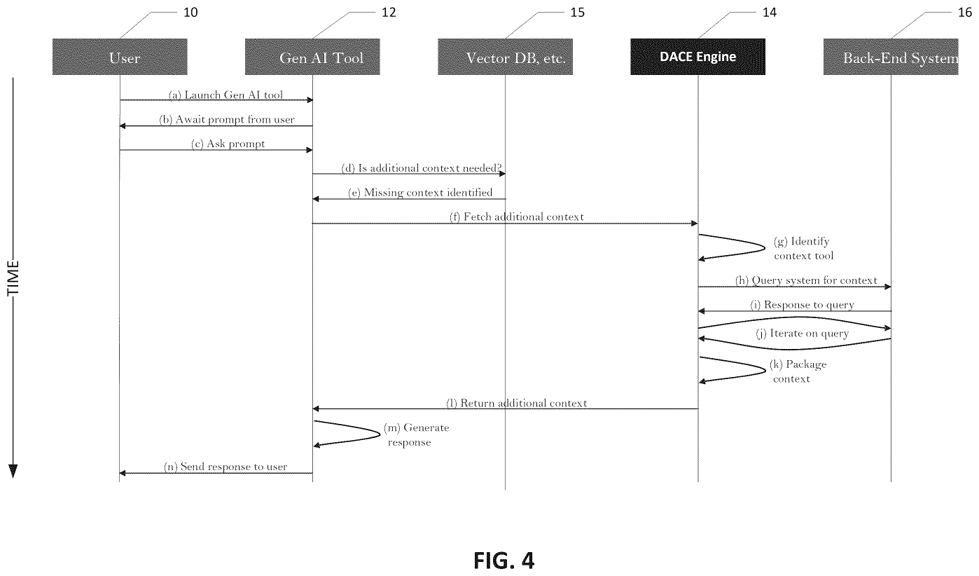

FIG. 4 is another diagram illustrating an order of operations for the components of the system of FIG. 2 according to various embodiments. The timing of the operations in FIG. 4 is top to bottom. Thus, starting at the top, the first step (a) is that the user 10 launches the gen-AI tool 12 for assistance for a software application, which awaits a prompt from the user 10 (step (b)). When the user 10 sends the prompt to the gen-AI tool 12 at step (c), the gen-AI tool 12 can then, in various embodiments, consult the vector database 15 at step (d) for whether additional context is needed to respond to the user's query. If no additional context is need, the gen-AI tool 12 can provide an answer to the user's prompt. Assuming, however, that additional context is required, at step (c) the vector database 15 can respond to the gen-AI tool 12 with additional context that it needs to answer the user's prompt, such as context related to performance, scalability and/or security issues for the application. At step (f), therefore, the gen-AI tool 12 can request the additional context from the DACE engine 14, which can, identify at step (g), which tool(s) or system(s) of the enterprise has the relevant context. After determining the tool(s) or system(s) with the relevant contextual information, the DACE engine 14 queries that tool(s)/system(s) for the contextual information at step (h). The step (i) the tool/system that was queried at step (h) responds, and this query/response paradigm can iterate, as shown by step (j), until the DACE engine 14 uncovers sufficiently granular information (e.g., a software function or class, or particular pod/VM statistics) to address the information requested by the gen-AI tool at step (f). At step (k), the DACE engine 14 packages the information to return to the gen-AI tool 12 at step (1). Based on this enriched, contextual information, the gen-AI tool 12 can generate a response at step (m) responsive to the user's original prompt at step (c), which the gen-AI tool 12 then sends to the user 10 at step (n).

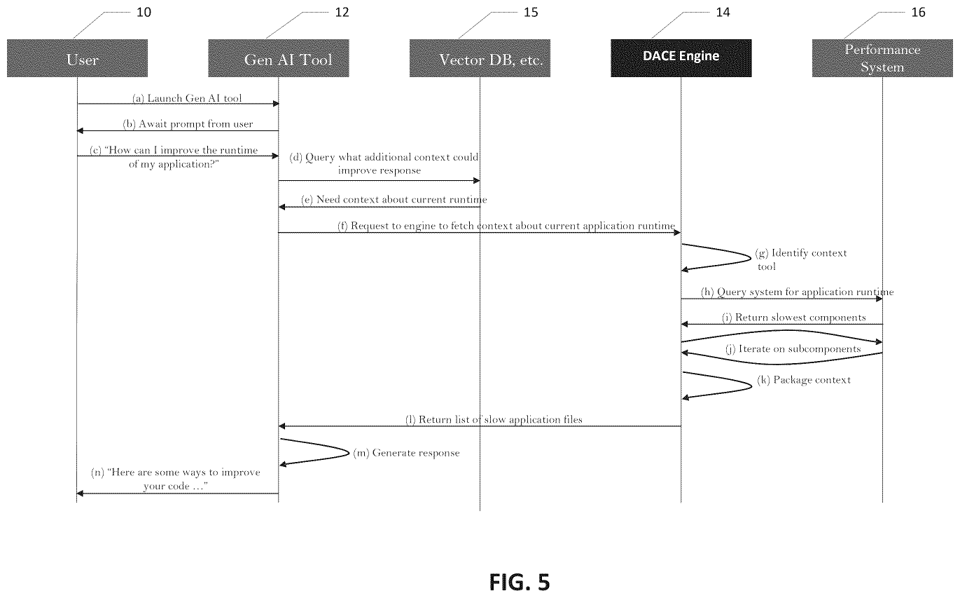

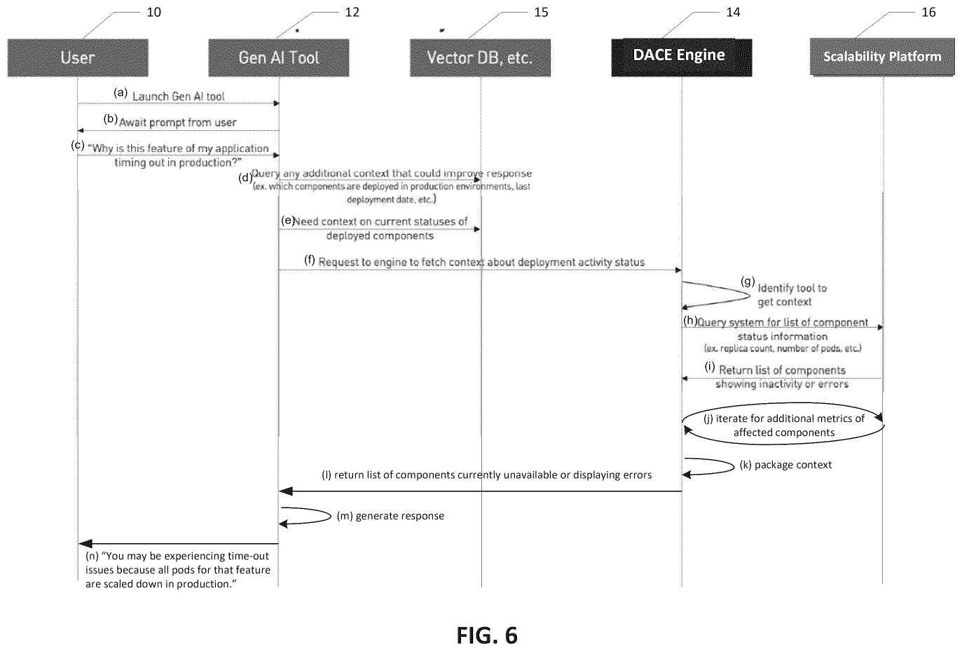

FIGS. 5 and 6 illustrate particular use case examples. In the example of FIG. 5, the user asks the gen-AI tool 12 how to improve the runtime of an application at step (c). The gen-AI tool 12 then queries the vector DB 15 at step (d) about what additional context is required to answer the user's question, the search query results, at step (c) are that context about current times for the application are needed. At step (f), the gen-AI tool 12 requests that the DACE engine 14 fetch context about current runtimes for the application. At step (g), the DACE engine 14 can determine that the enterprise's performance tool/system 16 (e.g., Dynatrace) is likely to have relevant information and at step (h) queries the performance tool/system 16 for application runtime information. In this example, the performance tool/system 16 can return the slowest running components of the application at step (i), and thereafter the DACE engine 14 can iterate at step (j) with the performance tool/system 16 to drill down to the subcomponents of the application that are the slowest. Once the slowest sub-components of the application are identified, a list of the slowest running sub-components/files for the application can be sent back to the gen-AI tool at step (1). Enriched with this context, the gen-AI tool 12 can provide a response step (n) that is particular to the enterprise and beyond what was merely available to the gen-AI tool 12 from the user's initial request at step (c). Also, by drilling down to the sub-components and/or files of the application that are the slowest, the DACE engine 14 reduces the number of tokens that needs to be sent to the gen-AI tool 12.

The example of FIG. 6 is where the user's application is timing out in production (see step (c)). At step (c), the query of the vector DB 15 for information that might be needed to answer the user's question is that context on the current statuses of deployed components for the application is needed. At step (f), the gen-AI tool 12 requests that the DACE engine 14 fetch information about the deployment activity status. At step (g), the DACE engine 14 can ascertain that the enterprise's scalability platform 16 is likely to have the desired context and, at step (h) queries the scalability platform (e.g., OpenShift) for a list of component status information for the application (e.g., number of pods, replica count, etc.). At step (i) the scalability platform 16, in this example, returns a list of components (e.g., pods or VMs) showing inactivity or errors. The DACE engine 14 and scalability platform 16 can then iterate at step (j) for additional metrics of the affected components, such as CPU usage, network latency, etc. Once the relevant metrics for the affected components are identified through this iteration, at step (k) the DACE engine 14 can package the results to send, at step (1) a list of components currently unavailable or displaying errors, for example. With this enriched contextual information, the gen-AI tool generates a response at step (m) to be sent at step (n) back to the user.

The DACE engine 14 could be implemented as a containerized application or as a cloud-based service, for example. The DACE engine 14 could comprise a natural language processing (NLP) engine for identifying the issue in the request from the AI-assisted code generation tool 12. The DACE engine 14 may also comprise a rules-based engine and/or a small language model (SLM) for determining which system(s) to query for the information to responds to the AI-assisted code generation tool's request. The rules-based engine and/or the small language model (SLM) could also evaluate the information that it receives from the system(s) in order to determine whether additional (e.g., more granular) information is needed at step 5.

In various embodiments, the AI-assisted code generation tool 12 may comprise, for example, a model that is customized (or tailored) to the enterprise of the DACE engine 14 so that the AI-assisted code generation tool 12 can craft better requests at step 2. Alternatively or additionally, the AI-assisted code generation tool 12 may comprise, for example, a vector database 15 that stores information that the model of the AI-assisted code generation tool 12 can leverage to craft more tailored requests at step 2 for the DACE engine 14.

As such, the architecture of FIG. 2, with the DACE engine 14, allows the AI-assisted code generation tool 12 to provide a broader range of responses to the end user 10. That is, the architecture of FIG. 2, with the DACE engine 14, can allow the AI-assisted code generation tool 12 to address issues extending beyond the files that the developer machine 10 has open. As such, the AI-assisted code generation tool 12, with data from the DACE engine 14, can address network-type issues for the enterprise, such as identifying a bottleneck in the application and improving it; scaling the application up or down; and otherwise improving the performance of the application.

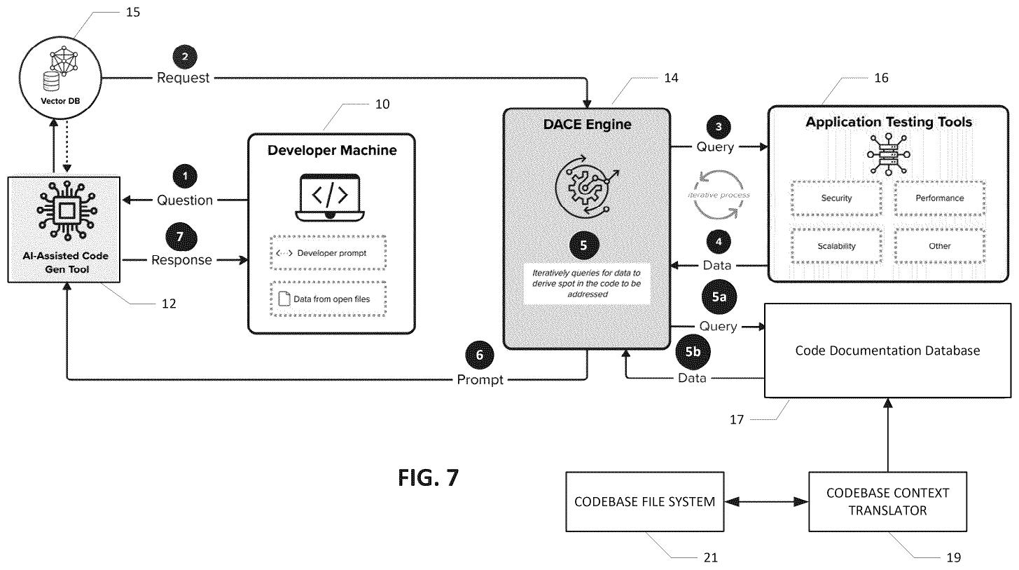

FIG. 7 is a diagram of the system architecture according to other embodiments of the present invention. The diagram of FIG. 7 is similar to the diagram of FIG. 2, except that the diagram of FIG. 7 shows additional components and correspondingly different steps. The additional components in FIG. 7 include a code documentation database 17, a codebase context translator 19, and a codebase file system 21. The codebase file system 21 can store one or more codebases for the enterprise. A codebase can include all the source code files, configurations, libraries, and other assets required to build, maintain, and run the software corresponding to the codebase. The codebase can be stored in, and the codebase file system 21 may implemented with, a local file system (hard drive or SSD), a repository hosted by a version control platform, in the cloud (e.g., Amazon S3, Azure Blob Storage, or Google Cloud Storage), and/or on a server(s) of the enterprise.

The codebase context translator 19 preferably is a software tool or framework that, relevant here, generates documentation about the code in the codebase, where the documentation can be forwarded by the DACE engine 14 to the AI-assisted code generation tool 12 to help the AI-assisted code generation tool 12 respond to the user's query. As shown in the example of FIG. 7, the documentation generated by the codebase context translator 19 can be stored in a codebase documentation database 17 that the DACE engine 14 can query to obtain relevant data (e.g., documentation) about the codebase.

In various embodiments, the codebase context translator 19 can access the codebase directly from the file system 21. For example, the codebase context translator 19 could be stored locally with the file system 21 and scan the source code files and directories to analyze the structure, relationships, and dependencies in the code. In other embodiments, the codebase context translator 19 may integrate directly into Integrated Development Environments (IDEs) like IntelliJ IDEA, Visual Studio, Eclipse, or NetBeans, which allows the codebase context translator tool to access the codebase via the IDE. In yet other embodiments, the codebase context translator 19 can connect to a version control system (VCS) like Git, Subversion (SVN), or Mercurial, and access the codebase through the VCS. In yet other embodiments, the codebase context translator 19 can interacts with repositories or cloud-based codebases through APIs provided by platforms like GitHub, GitLab, or Bitbucket, in which case the codebase context translator 19 can query the API to fetch the necessary code files or metadata to generate diagrams and documentation.

In various embodiments, the output of the codebase context translator 19 can comprise a graphical representation of the code of the codebase. Such a graph can visually map out the relationships and hierarchy between various components in the codebase, like: classes (e.g., displaying inheritance relationships, associations, or dependencies between classes); functions/methods (e.g., showing which functions belong to which classes, which functions call each other, or which functions are globally accessible); global variables (e.g., indicating where global variables are declared, used, or modified throughout the codebase); modules or files (e.g., showing how different files or modules within a project are linked or depend on each other); and/or data flows (e.g., mapping the flow of data between functions, classes, and variables). The graphs may be, for example, UML (Unified Modeling Language) diagrams or similar visual representations. The codebase context translator 19 may be implemented with a proprietary or commercial software tool, such as CodeCrawler or Imagix, which can generate the architecture diagrams from the codebase automatically.

The codebase context translator 19 can generate the codebase documentation (e.g., graphs) periodically or from time to time, so that the documentation can be precomputed and stored in the code documentation database 21 so that it is available in the code documentation database 21 when needed by the DACE engine 14. Also, in various embodiments, the codebase documentation could be created non-automatically, such as manually with software tools (e.g., LucidCharts and Enterprise Architect) that facilitate generation of such codebase documentation, with the non-automatically generated codebase documentation uploaded to the DACE engine 14. Such an embodiment can be beneficial of the architecture does not change frequently. Also, if the codebase is too large, utilizing a code reverse engineering architecture tool can help generate a static architecture diagram for the DACE engine 14. In yet other embodiments, such as of the codebase is relatively small and/or automatic generation tool are sufficiently fast, the codebase context translator 19 could generate the documentation as part of the process flow in response to each user query from the DACE engine 14.

To explain how the process works with the additional components of FIG. 7, once the DACE engine 14 resolves the granular information from the application testing tools 16 to respond to the AI-assisted code generation tool 12 (steps 3 through 5 of FIG. 7), the DACE engine 14 can query (at step 5a in FIG. 7) the code documentation database 17 for documentation (e.g., a codebase graph) about the issue identified by the DACE engine 14 through its interrogation of the application testing tools 16. For example, in a situation where the DACE engine 14 drills down to the slowest running sub-components/files of an application in response to a query about the runtime of the application (see FIG. 5), the DACE engine 14 can query the code documentation database 17 for documentation (e.g., graph) about the slow-running sub-components/files of the application. The code documentation database 17 can then respond with the relevant data at step 5b. Thereafter, the DACE engine 14 can then package that documentation to be sent back to the AI-assisted code generation tool 12 at step 6 so that the AI-assisted code generation tool 12 can thereafter respond back to the user at step 7. For example, the documentation may be sent to the AI-assisted code generation tool 12 as an XMI or XML file.

As another example (see FIG. 6), if the DACE engine 14 resolves the performance metrics for affected components for a timing out issue, the DACE engine 14 can query the code documentation database 17 for a graph for the application, which maps out the classes, functions, and modules, as well as their dependencies within the application, which can help the AI-assisted code generation tool 12 respond to the user's query. For example, if the application testing tools 16 identifies caches or queues being overloaded, the DACE engine 14 can use the documentation from the documentation database 17 to identify every queue that is being utilized within the codebase, with no context as to what is causing the overload.

The AI-assisted code generation tool 12 can run on servers, such as servers in the cloud or on the Internet, and it may be in communication with the developer machine 10 and the DACE engine 14 via the Internet or other type of electronic data network. The DACE engine 14 can run on a server(s) of the enterprise's on-premises network or on a cloud (public or private) network. Similarly, the application testing tools 16 and the codebase context translator 19 may run on a server(s) of the enterprise's on-premises network or on a cloud (public or private) network. The DACE engine 14, application testing tools 16 and the codebase context translator 19 may be implemented in computer software using any suitable computer programming language, such as PowerShell, .NET, C, C++, or Python, and using conventional, functional, or object-oriented techniques. The software may be stored in computer readable media, e.g., RAM, ROM, secondary storage, etc. One or more processing cores (e.g., CPU cores) of the servers may then execute the software to implement the functions provided by them. Programming languages for computer software and other computer-implemented instructions may be translated into machine language by a compiler or an assembler before execution and/or may be translated directly at run time by an interpreter.

In one general aspect, therefore, the present invention is directed to computer-implemented systems and methods for using an AI-assisted code generation tool with the DACE engine that collects, iteratively if necessary, contextual data about IT infrastructure of the enterprise, such as contextual information from architectural systems, tools and platforms of the enterprise. A method according to various embodiments of the present invention comprises the step of receiving, by the AI-assisted code generation tool, a user query from a user associated with an enterprise, where the AI-assisted code generation tool comprises a SaaS (Software as a Service) tool and the user query is received via an electronic data network. The method also comprises the step of transmitting, by the AI-assisted code generation tool, a request, via the electronic data network, to a dynamic application context enrichment (“DACE”) engine associated with the enterprise, where the request comprises a request for contextual data about IT infrastructure of the enterprise. The method also comprises the step of, in response to receiving the request, determining by the DACE engine the contextual data for the request, where the determining comprises querying, by the DACE engine, one or more application tools of the enterprise for the contextual data. The method also comprises, upon determining the contextual data, transmitting contextual data responsive to the request, via the electronic data network, by the DACE engine, to the AI-assisted code generation tool. And the method also comprises the step of responding, by the AI-assisted code generation tool, to the user with a response to the user's query, where the response is based on the contextual data received by the AI-assisted code generation tool from the DACE engine.

In another general aspect, the method comprises the steps of: receiving, by a DACE engine associated with an enterprise, via an electronic data network, a request from an AI-assisted code generation tool, where the request comprises a request for contextual data about IT infrastructure of the enterprise for the AI-assisted code generation tool to respond to a user query from a user associated with the enterprise, where the AI-assisted code generation tool comprises a SaaS tool; in response to receiving the request, determining by the DACE engine the contextual data for the request, where the determining comprises querying, by the DACE engine, one or more application tools of the enterprise for the contextual data; and upon determining the contextual data, transmitting contextual data responsive to the request, via the electronic data network, by the DACE engine, to the AI-assisted code generation tool such that the AI-assisted code generation tool can respond to the user with a response to the user's query, where the response is based on the contextual data received by the AI-assisted code generation tool from the DACE engine.

In various implementations, the methods further comprise the steps of: generating, by a codebase context translator, code documentation related to the IT infrastructure of the enterprise; storing the code documentation in a code documentation database; querying, by the DACE engine, the code documentation database for code documentation relevant to the request from the AI-assisted code generation tool; and transmitting, by the DACE engine, via the electronic data network, the code documentation relevant to the request to the AI-assisted code generation tool such that the response by the AI-assisted code generation tool to the user's query is based on the code documentation relevant to the request. In such implementations, the code documentation can comprise a graphical representation of a codebase of the enterprise.

In various implementations, querying, by the DACE engine, the one or more application tools of the enterprise for the contextual data comprises iteratively querying, by the DACE engine, the one or more application tools of the enterprise for the contextual data.

In various implementations, the one or more application tools comprises a software observability platform, a security tool for software development, and/or a scalability system for containerized applications.

In various implementations, the method further comprises: prior to transmitting, by the AI-assisted code generation tool, the request to the DACE engine, querying a vector database, by the AI-assisted code generation tool, in response to receiving the user request, for context to respond to the user request; and transmitting, by the AI-assisted code generation tool, the request to the DACE engine comprises transmitting the request to the DACE engine upon a determination by the AI-assisted code generation tool that the vector database has insufficient context to respond to the user request.

In various implementations, the method further comprises: generating, by a codebase context translator, code documentation related to the IT infrastructure of the enterprise; storing the code documentation in a code documentation database; querying, by the DACE engine, the code documentation database for code documentation relevant to the request from the AI-assisted code generation tool; and transmitting, by the DACE engine, via the electronic data network, the code documentation relevant to the request to the AI-assisted code generation tool such that the response by the AI-assisted code generation tool to the user's query is based on the code documentation relevant to the request.

In another general aspect, a system according to various embodiments of the present invention comprises an AI-assisted code generation tool, running on a first server system and a DACE engine running on a second server system. The AI-assisted code generation tool is for receiving a user query from a user associated with an enterprise, and the AI-assisted code generation tool comprises a SaaS tool and the user query is received via an electronic data network. The DACE engine is associated with the enterprise and is configured to: receive a request, via the electronic data network, from the AI-assisted code generation tool, where the request comprises a request for contextual data about IT infrastructure of the enterprise; in response to receiving the request, determine the contextual data for the request by querying one or more application tools of the enterprise for the contextual data; and upon determining the contextual data, transmit contextual data responsive to the request, via the electronic data network to the AI-assisted code generation tool. Also, the AI-assisted code generation tool is configured to response to the user with a response to the user's query, where the response is based on the contextual data received by the AI-assisted code generation tool from the DACE engine.

In various implementations, the system further comprises: a codebase context translator that is configured to generate code documentation related to the IT infrastructure of the enterprise; and a code documentation database for storing the code documentation. The DACE engine can be further configured to: query the code documentation database for code documentation relevant to the request from the AI-assisted code generation tool; and transmit the code documentation relevant to the request to the AI-assisted code generation tool such that the response by the AI-assisted code generation tool to the user's query is based on the code documentation relevant to the request. The code documentation can comprise a graphical representation of a codebase of the enterprise.

In various implementations, the DACE engine is configured to iteratively query the one or more application tools of the enterprise to resolve the contextual data.

In various implementations, the system further comprises a vector database for storing vectorized data about the IT infrastructure of the enterprise. Further, the AI-assisted code generation tool can be further configured to: prior to transmitting the request to the DACE engine, query the vector database in response to receiving the user request, for context to respond to the user request; and transmit the request to the DACE engine upon a determination by the AI-assisted code generation tool that the vector database has insufficient context to respond to the user request.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various aspects have been described herein, it should be apparent that various modifications, alterations, and adaptations to those aspects may occur to persons skilled in the art with attainment of at least some of the advantages. The disclosed aspects are therefore intended to include all such modifications, alterations, and adaptations without departing from the scope of the aspects as set forth herein.

What is claimed is:

1. A method comprising:
receiving, by an AI-assisted code generation tool, a user query from a user associated with an enterprise, wherein the AI-assisted code generation tool comprises a Saas (Software as a Service) tool and the user query is received via an electronic data network;
transmitting, by the AI-assisted code generation tool, a request, via the electronic data network, to a dynamic application context enrichment (“DACE”) engine associated with the enterprise, wherein the request comprises a request for contextual data about IT infrastructure of the enterprise;
in response to receiving the request, determining by the DACE engine the contextual data for the request, wherein the determining comprises querying, by the DACE engine, one or more application tools of the enterprise for the contextual data;
upon determining the contextual data, transmitting contextual data responsive to the request, via the electronic data network, by the DACE engine, to the AI-assisted code generation tool; and
responding, by the AI-assisted code generation tool, to the user with a response to the user's query, wherein the response is based on the contextual data received by the AI-assisted code generation tool from the DACE engine.

2. The method of claim 1, further comprising:
generating, by a codebase context translator, code documentation related to the IT infrastructure of the enterprise;
storing the code documentation in a code documentation database;
querying, by the DACE engine, the code documentation database for code documentation relevant to the request from the AI-assisted code generation tool; and
transmitting, by the DACE engine, via the electronic data network, the code documentation relevant to the request to the AI-assisted code generation tool such that the response by the AI-assisted code generation tool to the user's query is based on the code documentation relevant to the request.

3. The method of claim 2, wherein the code documentation comprises a graphical representation of a codebase of the enterprise.

4. The method of claim 1, wherein querying, by the DACE engine, the one or more application tools of the enterprise for the contextual data comprises iteratively querying, by the DACE engine, the one or more application tools of the enterprise for the contextual data.

5. The method of claim 1, wherein the one or more application tools comprises a software observability platform.

6. The method of claim 5, wherein the one or more application tools comprises a security tool for software development.

7. The method of claim 6, wherein the one or more application tools comprises a scalability system for containerized applications.

8. The method of claim 1, wherein:
the method further comprises, prior to transmitting, by the AI-assisted code generation tool, the request to the DACE engine, querying a vector database, by the AI-assisted code generation tool, in response to receiving the user request, for context to respond to the user request; and
transmitting, by the AI-assisted code generation tool, the request to the DACE engine comprises transmitting the request to the DACE engine upon a determination by the AI-assisted code generation tool that the vector database has insufficient context to respond to the user request.

9. A method comprising:
receiving, by a DACE engine associated with an enterprise, via an electronic data network, a request from an AI-assisted code generation tool, wherein the request comprises a request for contextual data about IT infrastructure of the enterprise for the AI-assisted code generation tool to respond to a user query from a user associated with the enterprise, wherein the AI-assisted code generation tool comprises a SaaS tool;
in response to receiving the request, determining by the DACE engine the contextual data for the request, wherein the determining comprises querying, by the DACE engine, one or more application tools of the enterprise for the contextual data; and
upon determining the contextual data, transmitting contextual data responsive to the request, via the electronic data network, by the DACE engine, to the AI-assisted code generation tool such that the AI-assisted code generation tool can respond to the user with a response to the user's query, wherein the response is based on the contextual data received by the AI-assisted code generation tool from the DACE engine.

10. The method of claim 9, further comprising:
generating, by a codebase context translator, code documentation related to the IT infrastructure of the enterprise;
storing the code documentation in a code documentation database;
querying, by the DACE engine, the code documentation database for code documentation relevant to the request from the AI-assisted code generation tool; and
transmitting, by the DACE engine, via the electronic data network, the code documentation relevant to the request to the AI-assisted code generation tool such that the response by the AI-assisted code generation tool to the user's query is based on the code documentation relevant to the request.

11. The method of claim 10, wherein the code documentation comprises a graphical representation of a codebase of the enterprise.

12. The method of claim 9, wherein querying, by the DACE engine, the one or more application tools of the enterprise for the contextual data comprises iteratively querying, by the DACE engine, the one or more application tools of the enterprise for the contextual data.

13. The method of claim 9, wherein the one or more application tools comprises a software observability platform.

14. The method of claim 13, wherein the one or more application tools comprises a security tool for software development.

15. The method of claim 14, wherein the one or more application tools comprises a scalability system for containerized applications.

16. A system comprising:
an AI-assisted code generation tool, running on a first server system, for receiving a user query from a user associated with an enterprise, wherein the AI-assisted code generation tool comprises a SaaS tool and the user query is received via an electronic data network;
a DACE engine running on a second server system, wherein the DACE engine is associated with the enterprise, and wherein the DACE engine is configured to:
receive a request, via the electronic data network, from the AI-assisted code generation tool, wherein the request comprises a request for contextual data about IT infrastructure of the enterprise;
in response to receiving the request, determine the contextual data for the request by querying one or more application tools of the enterprise for the contextual data; and
upon determining the contextual data, transmit contextual data responsive to the request, via the electronic data network to the AI-assisted code generation tool; and
wherein the AI-assisted code generation tool is configured to response to the user with a response to the user's query, wherein the response is based on the contextual data received by the AI-assisted code generation tool from the DACE engine.

17. The system of claim 16, wherein:
the system further comprises
a codebase context translator that is configured to generate code documentation related to the IT infrastructure of the enterprise; and
a code documentation database for storing the code documentation; and
the DACE engine is further configured to:
query the code documentation database for code documentation relevant to the request from the AI-assisted code generation tool; and
transmit the code documentation relevant to the request to the AI-assisted code generation tool such that the response by the AI-assisted code generation tool to the user's query is based on the code documentation relevant to the request.

18. The system of claim 17, wherein the code documentation comprises a graphical representation of a codebase of the enterprise.

19. The system of claim 16, wherein the DACE engine is configured to iteratively query the one or more application tools of the enterprise to resolve the contextual data.

20. The system of claim 16, wherein the one or more application tools comprises a software observability platform.

21. The system of claim 20, wherein the one or more application tools comprises a security tool for software development.

22. The system of claim 21, wherein the one or more application tools comprises a scalability system for containerized applications.

23. The system of claim 16, wherein:
the system further comprises a vector database for storing vectorized data about the IT infrastructure of the enterprise; and
the AI-assisted code generation tool is further configured to:
prior to transmitting the request to the DACE engine, query the vector database in response to receiving the user request, for context to respond to the user request; and
transmit the request to the DACE engine upon a determination by the AI-assisted code generation tool that the vector database has insufficient context to respond to the user request.
